(19) United States
(12) Patent Application Publication
(10) Pub. No.: US 2006/0093723 A1
(43) Pub. Date: May 4, 2006

(54) Shelf stable cheese composition and method of preparation

(76) Inventor: Aly Gamay, McLean, VA (US)

Correspondence Address: ALY GAMAY, 1102 Mill Riddes, McLean, VA, 22102, US

(21) Appl. No.: 10/975,260

(22) Filed: Oct. 29, 2004

(51) Int. Cl. A23C 19/00

(52) U.S. Cl. 426/582

(57) ABSTRACT

An acidified shelf-stable cheese composition and method of preparation are described. The resulting acidified shelf-stable cheese composition does not require refrigeration and exhibits desirable organolyptic properties.

### FIELD OF THE INVENTION

The present invention relates to a shelf-stable cheese and, more specifically, to such a cheese product that is shelf-stable at ambient temperature without refrigeration.

### BACKGROUND OF THE INVENTION

Cheese and cheese products are highly nutritious and popular in a variety of prepared foods and snack items. Several categories of hard, semi-soft and soft cheeses exist. Natural cheeses, i.e., Cheddar, Mozzarella, Romano, Blue, Parmesan, Cream and the like, are produced without further processing or adding other ingredients, while pasteurized processed cheese, i.e., American, spread and the like, entails further addition of ingredients and pasteurization. The aforementioned cheeses have standard compositional identities. On the other hand, cheese substitutes and cheese analogs, made from either dairy and/or non-dairy ingredients, have no such standard identities. If a cheese does not comply with a standard identity and contains essentially similar components to a standard cheese, but chemical and/or physical properties (i.e. % fat, % moisture) exist outside common levels, the cheese may be referred to as cheese product.

Typically, cheese is not shelf stable at room temperature, and requires special packaging and refrigeration during all phases of shipping, handling and marketing. Otherwise, spoilage will take place. Such rigid and exacting requirements during packaging and refrigeration limit the scope in which cheese can be utilized, particularly in industrial applications where many production facilities may lack refrigerated storage space. Furthermore, such a strict requirement for refrigeration limits distribution of cheese and related products in under-developed and developing countries where refrigeration facilities are not commonplace. Further limitations exist where storage precludes effective refrigeration.

The response to aforementioned problems has taken various approaches. Efforts to stabilize natural cheeses against spoilage by methods other than refrigeration have not been met with substantial commercial success. Processed cheese is considered one method to stabilize natural cheese. However, processed cheese does require refrigeration unless produced as shelf stable by observing critical factors.

Cheese products and cheese sauces are of great economic advantage due to the fact that they contain less cheese component, contain higher moisture and employ cheaper dairy and non dairy ingredients.

Attempts to produce shelf-stable cheese products have not produced satisfactorily commercial results. For instance, retorted products require no pre-use refrigeration, but such products must remain inside hermetically sealed containers. In any event, refrigeration is essential after opening the container in order to avoid spoilage. Retorting process encounters expensive equipment and packaging materials and require rigorous regimen in production adding to the cost of production.

Aseptic packaging has become popular in recent years. However, refrigeration of opened containers is necessary after opening and aseptic packaging process encounters expensive equipment and packaging materials and require rigorous regimen in production adding to the cost of production.

Furthermore, both retorting and aseptic packaging require stringent heat treatment which contribute to off-flavors and undesirable taste in the finished product limiting its acceptability by consumers.

Other approaches can be found in the prior art. Tanaka, et al., in the Journal of Food Protection, 1986, 49, 526-531, reported on known routes to high-moisture, low-acid cheese. As described therein, adjusting critical factors such as the concentration of emulsifiers, sodium chloride, moisture, along with manipulating the finished cheese pH, provides a high-water activity, shelf-stable cheese that does not support the growth and toxin production by Clostridium botulinum.

Other attempts to produce a processed cheese food product were described by Leung, et al., in Food Technology, 1976, 30, 42-44. Therein, dried skim-milk (up to about 24% and including about 50% lactose) and propylene glycol (up to about 4.5%) were added to Cheddar cheese. Even though the cheeses prepared had intermediate moisture contents, Aw=0.82-0.83, storage for four months at room temperature caused the texture of the products to become harder and drier.

U.S. Pat. No. 4,031,254 (Kasik et al.) teaches a dry composition which can be instantly reconstituted to a cheese sauce. The dry composition contains base-neutralized casein, fat, an alkali metal or alkaline earth metal salt, oxide or hydroxide and artificial or natural cheese flavor.

U.S. Pat. No. 4,568,555 describes a retorted Cheese sauce which is shelf stable, has good mouth feel and has superior tolerance to heat. The cheese sauce includes 5 to 15 weight percent of cheese, 0.1 to 0.7 weight percent of lactic acid, 0.2 to 0.6 weight percent of a nontoxic edible alkali metal salt or a nontoxic edible alkaline earth metal salt, 0.05 to 0.5 weight percent of a dairy protein, 0.5 to 5.0 weight percent of natural cheese flavor, 4.0 to 7.0 weight percent of at least one starch, 0.03 to 0.08 weight percent of carrageen gum, 0.2 to 0.4 weight percent of locust bean gum and guar gum, and 70 to 85 weight percent of water.

Adrianson, et al. describes in U.S. Pat. No. 5,670,197 a high-moisture, high-pH, shelf-stable cheese spreads containing cheese, preferably a cheese having a pH of 5.4 or lower such as Swiss, Cheddar, American, mozzarella, skim milk cheese, or cheese mixtures, water sufficient to provide a total moisture of from 51 to 58% and a pH of from 5.3 to 6.0 are preserved by adding sodium chloride, a phosphate salt, sodium citrate, and sodium lactate in sufficient amounts to maintain the composition free from the growth of Clostridium botulinum and the production of toxin by those organisms during room temperature storage for a period of at least 180 days, preferably 300 days. Some embodiments contain about 1 to 2% sodium citrate, about 1 to 2% sodium lactate, and a combined level of dibasic sodium phosphate and sodium chloride ranging between about 1.3 and 2.2%, and have a moisture content of 52 to 55%, and an overall pH of about 5.3 to 5.6.

Gamay, et al. described in U.S. Pat. No. 5,935,634 a shelf-stable cheese with a low-water activity, and method of preparation. The resulting shelf-stable cheese/composition does not require refrigeration and does not support the proliferation of microorganisms. It can be prepared as suitable for baking applications and/or a consistency appropriate for the desired food product.

Milk proteins are composed of casein and whey proteins. Casein is a phosphoprotein that exists in milk in the form of rather large colloidal particles containing the protein and also considerable quantities of calcium and phosphate and a little magnesium and citrate. These particles can be separated from milk by high-speed centrifugation, leaving the whey proteins and dissolved constituents in solution. They are commonly referred to as “calcium phosphocaseinate” or “calcium caseinate-phosphate.” Casein can be removed from milk in a number of ways besides high-speed centrifugation. The fundamental definition of casein is operational—it is defined as that protein precipitated from skim milk by acidification to pH 4.6 to 4.7. The calcium and phosphate associated with casein in the original particles progressively dissolved as the pH is lowered until, at the isoelectric point of pH 4.6 to 4.7, the casein is free of bound salts. A second important means of removing casein from milk is by rennet coagulation. The enzyme rennin has the ability to slightly change casein so that it coagulates in the presence of divalent cations such as calcium. This process is used in preparation of cheese curd. It involves the coagulation of the calcium caseinatephosphate particles as such because the pH does not drop and colloidal calcium and phosphate are not dissolved. Thus, the product prepared by rennet coagulation has high ash content as compared with acid-precipitated casein. Since they are stabilized by charge, the caseinate particles are extremely sensitive to changes in ionic environment. They readily aggregate with increase in concentration of these ions. Since their equilibrium dispersion in milk is rather precarious, minor changes in salt balance and pH easily upset this equilibrium and tend to destabilize and precipitate the casein particles. Whey proteins are composed of different fractions mainly lactalbumin and lactoglobulin. Milk contains approximately about 2.5% casein and about 0.6% whey proteins.

Processed cheese is very popular the United States of America consumed in variety of applications. Processed cheese production is a blend of art and science. Most processed cheese produced requires high level of intact casein (about 12%) and emulsifiers (up to 3%) to obtain proper functionality and characteristics in terms of firmness, metltability, elasticity and pH. Emulsifiers solubilize the casein and reduce fat separation. It is recommended that the pH of process cheese fall between 5.4 and 5.8 with optimal pH of 5.7 to 5.8. Below pH of 5.7, defects appear in process cheese such as grainy consistency, brittle texture, oily surface and sour flavor. Even cheese sauces with lower cheese content have in general a pH in the range of 5.2 to 5.7 for proper characteristics. If the cheese sauce is shelf stable by formulation according to The Tanaka study, increasing levels of emulsifying salts and salt have to be observed for shelf stability which may produce undesirable flavors or salty taste.

The titration curves of casein and Whey proteins (Principles of Dairy chemistry, R. Jenness, S. Patton, 1959, p. 227) reveal a significant difference between the titers of skim milk and rennet whey, it can be calculated that the 2.5% casein usually present in milk contributes a titer of about 0.8 meq./100 ml. between pH 6.6 and 8.3. The whey proteins contribute about 0.1 to 0.2 meq. Over the same range. In the titration of sour milk from pH 4.6-8.3, casein is responsible for about 2.5 meq. Per 100 ml. and whey proteins for 0.7 to 0.8 meq. Per 100 ml. It can be concluded from the abovementioned data that milk casein has about 4 to 6 times the buffering capacity of that of whey proteins.

21 CFR, Volume 2, Part 114 defines acidified foods as low-acid foods to which acid(s) or acid food(s) are added and which have a water activity (aw) greater than 0.85 and a finished equilibrium pH of 4.6 or below. The purpose of 21 CFR, Volume 2, Part 114 is to ensure safety from harmful bacteria or their toxins, especially the deadly Clostridium botulinum (C. botulinum). This can only be accomplished by adequate processing, controls, and appropriate processing methods, such as cooking the food at the proper temperature for sufficient times, adequately acidifying the food, or controlling water activity. C. botulinum is a living organism, which is almost universally present. Under certain conditions, C. botulinum can grow in foods and produce a powerful toxin, which affects the nervous system. C. botulinum will only grow in foods which: are packaged in the absence of oxygen; have a “favorable” pH and temperature; and contain water and nutrients necessary for its growth. Low-acid canned foods provide this favorable environment. When a product is acidified to a pH of 4.6 or less, according to FDA's Good Manufacturing Practices, inhibition of the growth of C. botulinum is assured. A manufacturer must manufacture, process and pack acidified foods so that a finished equilibrium pH value of 4.6 or below is achieved and maintained in all finished foods. Manufacturer must thermally process acidified foods to an extent necessary to destroy vegetative cells of microorganisms of public health significance and those of non-health significance capable of reproducing in the food under the conditions in which the food is stored, distributed, retailed and held by the user. Permitted preservatives may be used to inhibit the reproduction of microorganisms of non-health significance (in lieu of thermal processing).

Fortunately, Pathogen bacteria get killed during the proper heat treatments of various foods, thus limiting the health threats the bacteria may pose. However, spore formers and Toxin-producing microoragams such as Clostridium is a major concern. If the water activity of a given processed cheese stored at room temperature is not controlled precisely, outgrowth of Clostridium botulinum (which spores survive pasteurization temperature) may occur, producing a powerful toxin, which affects the nervous system. Ter Steeg, et al., Journal of Protection, 1995, 58, 1091-1099, found out that outgrowth occurred at 25 C with a water-activity of 0.96 and at pH's greater than 5.7. Lower pH's inhibits bacterial growth and proliferation.

Most of the processes and technologies developed to date fail to adequately address the pertinent issues regarding food safety and post-production contamination. For instance, retorted cheese products, as well as the cheeses developed as summarized in the Ter Steeg and Tanaka research, support post-production contamination with health threatening microorganisms. Almost without exception, refrigeration after purchase opening is essential, because when exposed to air, cheese is highly prone to deterioration

To produce acidified cheese products, large amount of acidifying agents would be required to reduce the pH to about or below 4.6 resulting in a sour or pickled taste that would not be accepted or tolerated by consumers. Higher cheese content in a given cheese composition may require elevated levels of inorganic emulsifiers, thus increasing the amount of acidifying agents needed and accentuating the sour taste.

In summary, there are a considerable number of deficiencies and problems relating to cheese products and compositions of the prior art. As discussed above, most such problems and deficiencies relate to shelf-stability and can be attributed to the cheese composition and/or the method by which it is prepared. There is a need for cheese, cheese products and/or cheese compositions meeting various criteria, including the following: (1) shelf stability at room temperature before opening the cheese product container (2) shelf stability after opening the cheese product container (3) Stability in terms of post production contamination of health threatening microorganisms (4) acceptability in terms of organoleptic characteristics, i.e. body and texture, flavor; as well as appearance and color (5) economics as being low cost formulation and processing cheese products.

### OBJECTS OF THE INVENTION

It is, therefore, an object of this invention to overcome the problems and deficiencies of the prior art, including the abovementioned, and/or to provide a cheese, cheese product and/or cheese composition having, among other attributes, met the criteria stated above.

It can also be an object of the present invention to provide a composition for a shelf stable cheese with pH about 4.6 or lower.

It is another object of the present invention to introduce an acidified shelf-stable cheese with high acidity that exhibits acceptable organoleptic qualities.

It is a further object of the current invention to provide a cheese that does not support the proliferation of food pathogens, during prolonged storage without refrigeration and produced without retorting, aseptic packaging or pathogen inhibiting combination of salt, inorganic emulsifiers and total solids.

It is another object of the present invention to provide a shelf-stable, low-pH processed cheese product that retains good taste and appearance qualities after heat treatment during preparation.

It is a further object of the current invention to provide a non-refrigerated shelf stable cheese product that is economical to produce.

Other objects, features and advantages of the present invention will be apparent from the following summary and description of preferred embodiments, and will be readily apparent to those skilled in the art having knowledge of cheese, cheese products and various methods for their preparation. Such objects, features, benefits and advantages will be apparent from the above as taken in conjunction with the accompanying examples, tables, data and all reasonable inferences to be drawn there from.

It will be understood by those skilled in the art that one or more aspects of this invention can meet certain objectives, while one or more other aspects can meet certain other objectives. Each objective may not apply equally, in all instances, to every aspect of the present invention. As such, the following objects, in light of the prior art regarding cheese and methods of preparation, can be viewed in the alternative with respect to any one aspect of the present invention.

### SUMMARY OF THE INVENTION

In part, the present invention is a pasteurized shelf stable cheese composition, comprising suitable proteinaceous material; water and an acidifying agent.

In highly preferred embodiments of such a cheese composition, the casein component of said suitable proteinaceous material and the inorganic emulsifier are present in an amount that would not require the addition of large amount of acidifying agents which results in an unacceptable sour or pickled taste. Regardless, such casein and inorganic emulsifier can be used in conjunction with one another to impact various textural and organoleptic properties.

In part, the present invention is also a shelf-stable cheese, including minimum amounts of acidifying agents and low-buffering whey proteins sufficient to provide an acidified cheese composition of about or below 4.6 pH.

In part, the present invention is also a cheese composition, including about 0.1 wt. % to 5.0 wt. percent non-casein protein. Without limitation, preferred embodiments can also include a texture enhancer and modifier such as one or more food quality hydrocolloids, proteins and starches. Likewise, in preferred embodiments, such a texture enhancer and modifier can be present in an amount sufficient to provide varied textural and organoleptic characteristics. A fat source may also be incorporated to affect various fat percentages in the final product.

In part, the present invention is also a method of using low or no organic emulsifiers to prepare a shelf-stable cheese product, having a pH of about or below 4.6. Such a method includes: (1) providing low-casein proteinaceous material and blending therewith water in an amount of about 40.0 wt. % to about 80.0 wt. % of the finished product, and (2) incorporating into the blend a texture modifier in an amount of about 0.1 wt. % to about 10.0 wt. % of the cheese product and (3) adding sufficient amount of acidifying agents to affect pH of about or below 4.6. As mentioned above and described more fully below, the texture modifier could be but not limited to gums, hydrocolloids, carbohydrates. Regardless of the proteinaceous material used, the texture modifier t used with this method can be one of various commercially available edible food quality ingredients, or a combination of such ingredients.

In part, the present invention is also a method of preparing a shelf-stable cheese. Such a method includes: (1) providing a blend of texture modifiers in an amount of about 0.1 wt. % to about 15.0 wt. % of the cheese product and (2) adding sufficient amount of water to obtain a slurry of about 40.0 wt. % to 70 wt. % moisture and (3) mixing the slurry with a fat source and (4) adding sufficient amount of acidifying agents in an amount sufficient to provide a predetermined acidity level.

In preferred embodiments, the pH level is such that the resulting cheese meets the various criteria of shelf-stability as acidified foods, as further discussed herein. In preferred embodiments, a pH of about 4.6 or below is provided.

As mentioned above and described more fully below, it has been discovered that an acceptable cheese product of about or below 4.6 pH is attainable if the appropriate casein level, high-buffering proteinaceous materials and emulsifier's type and level are employed. In particular, and without limitation, it has been discovered through this invention that reduced amounts of acids will control the acidity without adversely affecting the flavor or texture of the finished product, even if heated during processing.

A desirable aspect of stability in the context of this invention is the addition of various types of fats. While not required to attain other attributes of this invention, certain advantages are realized if fat is present in the acidified cheese product to affect varied organoleptic and textural attributes.

### DETAILED DESCRIPTION OF THE INVENTION

The invention summarized above is more particularly described below and in the following examples. Both the descriptions and examples are intended as illustrations only, as numerous modifications and variations consistent with this invention will be apparent to those skilled in the art having knowledge of it.

Proteinaceous materials utilized in the invention could be either casein and casein containing or non-casein containing.

Casein and Casein-containing proteinaceous materials includes natural cheeses and dehydrated cheeses such as Cheddar Monterey Jack, Colby, Mozzarella, Romano, Parmesan, Cream, and or Skim-milk cheeses may be utilized separately or combined as the casein cheese component herein. Skim milk, fermented milk or skim milk, butter milk, nonfat dry milk, milk protein concentrate, caseinate salts such as sodium and calcium caseinate, rennet casein, whole milk and dry milk may also be suitable sources for casein and casein-containing proteinaceous materials. Such sources for casein-containing proteinaceous materials can be considered separately or as part of a more general group of suitable proteinaceous materials including milk casein. Plant soy proteins and the like such as tofu and soy curd may also be employed according to the present invention. Nonetheless, the amount of casein in the casein-containing proteinaceous material component ranges between 0.0 and 5.0 wt. %, preferably about 0.0 to 1.0 wt. %, as a mechanism to control the buffering capacity of the blend, and, consequently, the amount of acidifying agents need to be added. Varying amounts of other suitable proteinaceous materials can be used consistent with this discussion and/or as supplemented with a suitable amount of fat or oil component, as desired for a particular cheese composition. Furthermore, if the casein-containing proteinaceous materials component is too high, increased amounts of inorganic emulsifiers need to be utilized to solubilize the casein component for proper melting and functionality of finished cheese product. The aforementioned situation adversely impacts the acidity manipulation and becomes problematic in terms of producing acidic or pickled taste in the self-stable cheese. For this reason, the control of the amount of casein-containing proteinaceous materials can be used to control the amount of added acidifying agents and impart an acceptable flavor at the needed pH level of 4.6 or below. One of the surprising discoveries of the current invention, is that because of the high buffering capacity of casein (about 4 to 6 times that of whey proteins), if elevated amount of native casein exists, larger amount of acidifying agents are needed to affect pH about or below 4.6 resulting in an objectionable sour taste and undesirable pickled and acidic characteristics in the finished shelf stable cheese product. In addition, casein to the contrary to whey proteins, it requires inorganic emulsifiers to be processed into a cheese product. Varying amounts of inorganic emulsifiers are required to emulsify the casein for proper processing and functionality. Those amounts of inorganic emulsifiers relates proportionally to the amount of casein in the formulation. The higher the cheese or the casein content, the more inorganic emulsifiers are required. It is well known in the art of processed cheese that inorganic emulsifiers that raise the pH of the cheese blend are preferred and commonly utilized in processing. The higher the pH of the blend, the more acidifying agent is needed to decrease the pH of the finished product to about or below 4.6 resulting in a defective product. Based on the aforementioned findings, the amount of casein-containing proteinaceous materials should be minimized to obtain the proper functionality and desirable characteristics of the shelf stable cheese product.

Non casein-containing proteinaceous materials are those of milk or plant origin and contain none or very low levels of casein. An example of such materials is whey proteins, wheat and corn proteins and other soy protein isolates. Also high whey protein containing products such as Ricotta cheese and the like may be utilized. Such materials may be employed as liquids, pastes, soft consistency, slurries or dehydrated forms. Non casein-containing proteinaceous materials may be used in the range of about 0.1 wt. % to 5.0 wt. %. Whey proteins are the preferred non casein-containing proteinaceous materials since they impart dairy/cheese like flavor and taste as well as they provides creamy spreadable consistency to the finished shelf stable cheese. Another surprising discovery of the current invention, is that because of the low buffering capacity of whey proteins (about ¼ to ⅙ that of casein) small amount of acidifying agents are needed to affect pH about or below 4.6 resulting in very minimal sour taste in the finished shelf stable cheese product. In addition, whey proteins to the contrary to casein, do not required inorganic emulsifiers to be processed into a cheese product. No or little inorganic emulsifiers in conjunction with whey proteins may be need under such circumstances. Moreover, whey proteins do not coagulate at pH of about 4.6 (casein isoelectric point is a pH about 4.6-4.8) resulting in a creamy consistency and desirable appearance.

Suitable inorganic emulsifiers and nontoxic edible alkali metal salt and/or nontoxic edible alkaline earth metal salt may be selected from any edible or food grade products, including without limitation: phosphates, citrates, Hexametaphosphate, aluminum phosphates, pyrophosphates and polyphosphates. Examples of other useful water-soluble nontoxic edible alkali metal salts and alkaline earth salts are sodium aluminum phosphate, sodium citrate, potassium citrate, potassium phosphate, calcium citrate, sodium tartrate, and sodium potassium tartrate, di and trisoduium phosphates. The appropriate emulsifier traditionally may be used to control pH of the cheese products and consequently prevent fat separation. The amount used is dependent upon the specified emulsifier used, the amount of cheese and the pH desired. Depending on the type of emulsifier used, the pH may be raised (as in the case of di- and trisodiumphosates) or decreased (as in the case of monosodium phosphate). Inorganic emulsifiers that lower the pH are preferred in the current invention. An example of such pH-lowering inorganic emulsifiers is monosodium phosphate. The higher the amount of pH raising emulsifier, the more acidifying agent is required to affect a pH of 4.6 or below. Additional surprising discovery of the current invention is that no or very little inorganic emulsifiers may be employed in the preparation of the current composition. In general the amount of inorganic emulsifier could be in the range of about 0.01 wt. % to 0.5 wt. %.

Organic emulsifiers that can also be used include without limitation lecithin, mono-glycerides, di-glycerides, and sodium stearoyl lactylate, polysorbates and alike. Again, all are observed to reduce or inhibit fat separation. For instance, organic emulsifiers were found to be a very effective agent in the current invention when added to the cheese mix at 0.1 to 0.5 wt. %, preferably at 0.2 wt. %.

Acidifying agents play a significant rule in this invention by controlling the pH of the acidified shelf stable cheese. Any food grade acids can provide the necessary pH reduction or control. Organic acids such as acetic, adipic, citric, malic, lactic, succinic, ascorbic, benzoic, erythorbic, propionic, sorbic, tartaric and glucono delta-lactone and any inorganic acids such as phosphoric, sulfuric and hydrochloric acids can also be used separately or in combination to achieve the proper acidification. The amount of acidifying agent may vary according to the amount of cheese, casein and casein-containing proteinaceous materials and the type and amount of inorganic emulsifiers used. The acidifying agent may be added as a concentrate or diluted solution at any stage of the processing of the cheese product, preferably towards the end of pasteurization at approximately 160-190 F. Other ingredients with pH-lowering properties such as monosodium phosphate and sodium bisulfate may be used. The inclusion of about 0.1 to about 1.5 wt. %, based on the total weight of the cheese, of various acids in the invention cheese sauce is quite useful. Preferably about 0.7 wt. % of lactic acid and glucono delta-lactone is used.

It is also practical to utilize naturally and artificially acidified products and food products to affect the appropriate pH for providing the shelf stability of the acidified cheese product. Sour cream, yoghurt, buttermilk, acid whey, fermented dairy products, acidified food products at various physical forms as dry, liquids and pastes may be utilized at various quantities to control the pH. For example, acid whey may be added at 2.0 to 15 wt. %, yoghurt may be incorporated at 1.0 to 6.0 wt. % to manipulate the acidity and accordingly the pH of the acidified shelf stable cheese product.

At least one food texture-enhancing agent is utilized in order to impart desirable textural properties. The texture-enhancing agent could be selected from a group that include but not limited to starches, carbohydrates, hydrocolloids and proteins.

The starch may be any of the natural, unmodified or modified food grade starches. Starch in the amount of about 0.05 to about 8.0 wt. %, preferably 4.0 weight % based on the total weight of the cheese, may be used in the invention. Preferably the starch is a corn starch, with a mixture of corn starches being even more preferred. Examples of suitable food starches which can be used in the shelf stable cheese are those of wheat, sorghum, rice, casaba, potato, tapioca, arrowroot, sago palm and mixtures thereof. Preferably the corn starch is a pregelatinized (modified) waxy maize starch, because it was found to best provide the desired mouth feel in the cheese.

Several gums and stabilizers can also be incorporated into the cheese of this invention. The gum may be any of the well known hydrocolloid gums used in the manufacture of processed cheese products and other food products. The gum may be selected from the group consisting of gum karaya, gum tragacanth, carob bean gum, gelatin, sodium alginate, propylene glycol alginate, guar gum, sodium carboxymethyl cellulose, carrageenan, microcrystalline cellulose and xanthan gum. Gelatin (mainly protein) may also be used as a part of the gum system. The invention cheese composition may use a combination of hydrocolloidal gums, in certain ranges and ratios, which are critical to achieving good mouth, feel in the cheese. The combination of hydrocolloidal gums is about 0.03 to about 0.8 wt. % t, preferably about 0.5 wt. %, based on the total weight of the cheese.

Other carbohydrates such as corn syrups, syrups, corn syrup solids, maltodextrin with various dextrose equivalents and like may be employed in the current invention to impart textural enhancing characteristics.

Other additives may additionally be incorporated in the current composition. Water is added to influence the consistency and functionality of the shelf stable composition. Water is not a critical factor in formulating the current cheese composition because, unlike other shelf stable cheeses by formulation, the preservation is accomplished by lowering the pH to about or below 4.6. About 40 to about 80 wt. %, preferably about 64 wt. %, based on the total weight of the cheese composition, of water may be used.

Because of the dependability of the current composition on low pH of about 4.6 or below, the amount of added salt is not crucial for preservation. Salt may be added at any amount that provides desirable taste.

The cheese composition can contain about 2 to about 25.0 wt. % based on the total weight of the cheese product, of vegetable fat. The vegetable fat is preferably oil such as coconut oil, palm and palm kernel oil, corn oil, cottonseed oil, soybean oil, safflower oil or a partially hydrogenated vegetable shortening. The vegetable fat should have essentially a bland taste and best is liquid at a temperature of less than about 130.degree. F. Mixtures of vegetable fats can be used. Animal fats, such as butterfat, may be used in the invention.

A natural or artificial dairy and cheese flavors in the amount of about 0.1 to about 5.0 wt. % may be used to impart various flavors. Other spices and particulate may be incorporated to produce shelf stable cheese with different characteristics.

The cheese sauce can contain about 0.1 to about 0.8 wt. %, based on the total amount of the cheese product, of natural or artificial colorant. The specific certified food colorant used can be chosen to provide the exact shade desired in the cheese product.

Anti-microbial agents can be, but do not have to be, incorporated in the cheese product. The cheese product does not have to include such anti-microbial agents, but they may be incorporated to retard the activity of molds and yeasts after opening the containers. Examples of useful anti-microbial agents are sorbic acid, propionic acid, benzoic acid and their derivatives.

The cheese spreads are made as known to the art other than for the use of the newly-discovered effective preservation system and the method for its use. In this regard, the procedure of Example 3 is effective as are those of the above-noted references. Typically, the procedure will entail mixing liquid ingredients such as cream, water, milk, and the like, with soluble solids such as salt, whey protein concentrates, emulsification agents such as the phosphates or citrates, colorants, flavorants, spices, gums, starches or other thickeners, and possibly antimycotics such as potassium sorbate or the like. The resulting mixture is blended and heated while the cheese is added, preferably in grated form with the aid of a scraped-surface mixing kettle or process cheese processor. The ingredients are agitated until the mixture is smooth. Following mixing of the ingredients, the cheese mixture is heated to a processing temperature of about 160 to 190 degree. F. and the ingredients blended until smooth. Acidifying agents are then added. Specific instructions and variation for the preparation of cheese products according to the invention are given in greater detail in the examples that follow.

An advantage of the invention is that a shelf-stable cheese product exhibiting high moisture and low pH can be made by the simple process of traditional processed cheese but when made according to the method of the invention exhibit good organoleptic characteristics as well as shelf stability, with the range of cheeses expanded over prior art products.

With respect to the methods, compositions or products of the present invention, the various ingredients, components or materials, whether or not in the amounts or concentrations expressed is compositionally distinguishable, characteristically contrasted, and can be practiced in conjunction with the present invention separate and apart from any other such component, ingredient or material. Accordingly, it should be understood that the inventive methods and/or compositions, as illustratively disclosed herein, can be practiced or utilized in the absence of any one component, ingredient, material and/or step, which may or may not be disclosed, referenced or inferred herein, the absence of which may or may not be specifically disclosed, referenced or inferred herein.

### EXAMPLES OF THE INVENTION

The following non-limiting examples and data illustrate various aspects and features relating to the inventive compositions, cheese products and/or methods described herein, including the surprising and unexpected results obtained through use of proteinaceous materials, texture enhancers and acidifying agents in providing an acidified, shelf-stable cheese at a pH which is critical to obtain shelf stability without refrigeration.

### Example 1

To illustrate the difference between the buffering capacity of milk casein and that of whey proteins, the following experiment was implemented:

Protein solutions of either 80% whey protein concentrate (WPC) or non fat dry milk (NFDM) was prepared by dissolving the proteins in water at 5% and 10%. After heating the solutions to 170 F and cooling to room temperature, a 33% lactic acid solution was added to decrease the pH from 6.7 to 6.8 to about 4.6. Milliliters (ml) of 33% lactic acid solution needed to drop pH of the protein solutions to about 4.6 were recorded. The titration results were as follows:

| | | ml 33% Lactic Acid |
|---|---|---|
| Protein Solution | ml 33% Lactic Acid | per 100% Protein |
| 5% NFDM | 1 | 4.00 |
| 10% NFDM | 2 | 8.00 |
| 5% WPC | 1 | 0.82 |
| 10% WPC | 2 | 1.65 |

When analyzing the data based on 100% protein unit, since WPC contains 80% protein and NFDM contains approximately 25% casein, it could be concluded that the buffering capacity of 100% casein is about 3.2 times that of whey proteins. That finding is in agreement with published data relating to buffering capacity of milk proteins. The data emphasize the importance of controlling the amount of casein and casein-containing proteinaceous materials in order to control the buffering capacity of the dairy product, thus minimizing the amount of acidifying agents needed to obtain a pH of about 4.6 or below.

### Example 2

To illustrate the difference between the buffering capacity of dibasic phosphates such as disodium phosphate and that of monobasic phosphates such as monosodium phosphate, the following experiments were implemented:

Phosphate solutions of either disodium phosphate (DSP) or monosodium phosphate (MSP) were prepared by dissolving the phosphates in water at 1.5 and 3% of each. After heating the solutions to 170 F and cooling to room temperature, the pH of solutions was measured. Both DSP solutions had pH value about 9.2 and MSP solutions had a pH value of about 4.4 indicating that MSP is more effective in obtaining the proper pH for shelf stability.

To additionally illustrate the difference between the buffering capacity of dibasic phosphates such as disodium phosphate and that of monobasic phosphates such as monosodium phosphate when added to cheddar cheese formulation for producing processed cheese, the following experiments were executed:

Cheese solutions of 10% cheddar cheese were prepared by dissolving the cheese in water. Either DSP or MSP were added at 3.0%. After heating the solutions to 170 F and cooling to room temperature, a 33% lactic acid solution was added to decrease the pH from initial pH to about 4.6. Milliliters (ml) of 33% lactic acid solution needed to decrease pH of the protein solutions to about 4.6 were recorded. The titration results were as follows: DSP cheese solution: to decrease the initial pH from about 7.5 to a final pH of about 4.6, 7 ml of 33% lactic acid solution was needed. MSP cheese solution: to decrease the initial pH from about 4.9 to a final pH of about 4.6, 0.5 ml of 33% lactic acid solution was needed.

The data emphasize the importance of selecting the type of emulsifier in order to control the buffering capacity of the cheese product, thus minimizing the amount of acidifying agents needed to obtain a pH of about 4.6 or below. Furthermore, as it is evident in the abovementioned example, the preferred emulsifier in the acidified cheese products is a monobasic phosphate that does not raise the pH of the product to pH far from the desired pH of about 4.6 or below.

### Example 3

A shelf-stable processed cheese product lower in pH value than conventional processed cheese (usually has a range of about 5.6 to 5.8) was formulated as follows:

| Ingredient | Weight percentage |
|---|---|
| Mild Cheddar cheese | 8.00 |
| Whey protein concentrate 34% | 3.00 |
| Vegetable shortening | 20.00 |
| Monosodium phosphate | 0.20 |
| Salt | 1.00 |
| Modified food starch | 3.00 |
| Xanthan gum | 0.20 |
| Maltodextrin | 2.00 |
| Mono and diglycerides | 0.20 |
| Cheese flavor | 1.50 |
| Lactic acid | 0.80 |
| Cheese color | 0.20 |
| Water | 59.90 |

One thousand grams of this formulation was processed in an experimental processed cheese cooker. The moisture content was about 62.80%, fat content was about 22.50% and the pH was about 4.6.

### Example 4

A shelf-stable processed cheese product with desirable eating qualities was formulated as follows:

| Ingredient | Weight percentage |
|---|---|
| Mild Cheddar cheese | 1.00 |
| Whey protein concentrate 34% | 6.00 |
| Vegetable shortening | 20.00 |
| Salt | 1.00 |
| Modified food starch | 3.00 |
| Xanthan gum | 0.20 |
| Maltodextrine | 3.00 |
| Mono and diglycerides | 0.30 |
| Cheese flavor | 0.50 |
| Lactic acid | 0.60 |
| Cheese color | 0.20 |
| Water | 64.20 |

One thousand grams of this formulation was processed in an experimental processed cheese cooker. The moisture content was 64.30% and the pH was 4.5 the product showed good eating qualities and spreadability.

### Example 5

An acidified shelf-stable processed cheese product that does not contain any cheese component was formulated as follows:

| Ingredient | Weight percentage |
|---|---|
| Whey protein concentrate 34% | 7.00 |
| Vegetable shortening | 16.00 |
| Monopotassium phosphate | 0.10 |
| Salt | 1.00 |
| Modified food starch | 5.50 |
| Non fat dry milk | 2.2 |
| Xanthan gum | 0.20 |
| Maltodextrin | 3.00 |
| Mono and diglycerides | 0.30 |
| Cheese flavor | 0.50 |
| Lactic acid | 0.50 |
| Cheese color | 0.20 |
| Water | 63.30 |

One thousand grams of this formulation was processed in an experimental processed cheese cooker. The moisture content was about 63.30%, the fat content was about 16.00% and the pH was 4.5 the product showed good organoleptic characteristics and spreadability.

### Example 6

Ninety pounds of shelf-stable, low-pH processed cheese product was produced in a direct steam injection processed cheese cooker utilizing the following ingredients:

| Ingredient | Weight percentage |
|---|---|
| Mild Cheddar cheese | 0.10 |
| Whey protein concentrate 34% | 6.00 |
| Vegetable shortening | 18.00 |
| Monosodium phosphate | 0.30 |
| Salt | 1.00 |
| Modified food starch | 5.50 |
| Non fat dry milk | 0.50 |
| Xanthan gum | 0.20 |
| Sodium alginate | 0.20 |
| Maltodextrin | 3.00 |
| Mono and diglycerides | 0.30 |
| Cheese flavor | 0.50 |
| Lactic acid | 0.30 |
| Sorbic acid | 0.10 |
| Sodium bisulfate | 0.40 |
| Cheese color | 0.25 |
| Water | 63.35 |

The resultant cheese composition had the following chemical composition: 63.50% moisture, 18.10% fat and a pH of 4.3. The product exhibited excellent eating quality and appearance.

### Example 7

An acidified shelf-stable processed cheese product that employ fermented dairy products as acidifying agent was formulated as follows:

| Ingredient | Weight percentage |
|---|---|
| Mild Cheddar cheese | 1.00 |
| Whey protein concentrate 34% | 1.00 |
| Acid whey solids | 6.00 |
| Yoghurt | 4.00 |
| Sour cream | 4.00 |
| Vegetable shortening | 12.00 |
| Monosodium phosphate | 0.10 |
| Salt | 1.00 |
| Modified food starch | 2.50 |
| Butter milk | 3.00 |
| Xanthan gum | 0.20 |
| Maltodextrin | 3.00 |
| Mono and diglycerides | 0.30 |
| Cheese flavor | 0.50 |
| Lactic acid | 0.10 |
| Cheese color | 0.20 |
| Water | 61.10 |

One thousand grams of this formulation was processed in an experimental processed cheese cooker. The moisture content was 61.10% and the pH was 4.6 the product showed good organoleptic properties and spreadability.

### Example 8

A shelf-stable processed cheese like product that does not contain any proteinaceous material was formulated as follows:

| Ingredient | Weight percentage |
|---|---|
| Vegetable shortening | 22.00 |
| Salt | 1.80 |
| Modified food starch | 6.50 |
| Xanthan gum | 0.20 |
| Maltodextrin | 4.00 |
| Mono and diglycerides | 0.20 |
| Cheese flavor | 2.00 |
| Lactic acid | 0.50 |
| Citric acid | 0.20 |
| Cheese color | 0.20 |
| Water | 62.4 |

One thousand grams of this formulation was processed in an experimental processed cheese cooker. The moisture content was about 62.10%, fat content was about 22.50% and the pH was about 4.6. The cheese product exhibited similar characteristics of processed cheese sauce.

### Example 9

Soy protein and soy protein isolates were investigated as protein sources for the shelf-stable, low-pH processed cheese product. The formulation was carried out as follows:

| Ingredient | Weight percentage |
|---|---|
| Tofu | 4.00 |
| Soy protein isolates | 2.00 |
| Vegetable shortening | 18.00 |
| Monosodium phosphate | 0.30 |
| Salt | 1.00 |
| Modified food starch | 2.50 |
| Xanthan gum | 0.20 |
| Sodium alginate | 0.20 |
| Maltodextrin | 3.00 |
| Mono and diglycerides | 0.10 |
| Liquid dairy flavor | 0.50 |
| Glucono delta lactone acid | 0.60 |
| Sodium bisulfate | 0.30 |
| Cheese color | 0.25 |
| Water | 67.35 |

The resultant product had the following chemical composition: 69.80% moisture, 18.10% fat and a pH of 4.5. The product, which is categorized as a non-dairy cheese spread, exhibited acceptable characteristics.

While the principals of this invention have been described in connection with specific embodiments, it should be understood clearly that these descriptions, along with the chosen tables and data therein, are made only by way of example and are not intended to limit the scope of this invention, in any fashion. For example, as compared to the prior art, the compositional parameters of the present invention can be modified as described herein, as a further basis for distinction over the prior art. In addition, many of the ingredients or components specified in the preceding examples are present and/or utilized to optimize various qualities and characteristics as they may apply to taste, appearance and/or end use application. However, it should be understood that other such qualities and characteristics, such as low pH, shelf stability, and economical advantages, can be achieved as more broadly described herein, without such specified components or ingredients. Other advantages and features of this invention will become apparent from the following claims, with the scope thereof determined by the reasonable equivalence, as understood by those skilled in the art.

What is claimed is:

1. A pasteurized shelf stable cheese composition, comprising
a suitable proteinaceous material;
water;
acidifying agent; and
texture enhancing agent

2. The pasteurized shelf-stable cheese composition of claim 1 wherein said proteinaceous material is a casein-containing proteinaceous material present at a level sufficient to provide from about 0.05 weight percent to about 5.0 weight percent casein in the cheese product.

3. The pasteurized shelf-stable cheese composition of claim 3 wherein said casein-containing proteinaceous material is selected from the group consisting of natural and processed cheese, dairy products, plant products and combinations thereof.

4. The pasteurized shelf-stable cheese composition of claim 1 wherein said proteinaceous material is a non casein-containing proteinaceous material present at a level sufficient to provide from about 1.0 to weigh percent about 5.0 weigh percent non casein protein in the cheese product.

5. The pasteurized shelf-stable cheese composition of claim 4 wherein said non casein-containing proteinaceous material is selected from the group consisting of whey solids, liquid whey, whey concentrate, whey protein concentrate and whey based cheese and combinations thereof.

6. The pasteurized shelf-stable cheese composition of claim 1 wherein said water is present at in an amount of about 40.0 weigh percent to about 80.0 weigh percent of said cheese composition.

7. The pasteurized shelf-stable cheese composition of claim 1 wherein said acidifying agent is present at a level sufficient to provide a pH of about 4.6 or below in the cheese product.

8. The pasteurized shelf-stable cheese composition of claim 1 wherein said acidifying agent is selected from the group consisting of organic acids such as acetic, adipic, citric, malic, lactic, succinic, ascorbic, benzoic, erythorbic, propionic, sorbic, tartaric, glucono delta-lactone, organic acids such as phosphoric, sulfuric and hydrochloric acids, naturally and artificially acidified products and food products and combinations thereof.

9. The pasteurized shelf-stable cheese composition of claim 1 wherein said texture enhancing agent is present at a level sufficient to provide from about 0.1 weight percent to about 10.0 weight percent of the pasteurized shelf-stable cheese.

10. The pasteurized shelf-stable cheese of claim 1 wherein said texture enhancing agent is selected from the group consisting of starches, carbohydrates, hydrocolloids and textural proteins and combinations thereof.

11. An acidified shelf-stable cheese composition, comprising
a suitable proteinaceous material;
water;
inorganic emulsifier; and
acidifying agent

12. The acidified shelf-stable cheese composition of claim 11 wherein said proteinaceous material is a casein-containing proteinaceous material present at a level sufficient to provide from about 0.05 weight percent to about 5.0 weight percent casein in the cheese product.

13. The acidified shelf-stable cheese composition of claim 12 wherein said casein-containing proteinaceous material is selected from the group consisting of natural and processed cheese, dairy products, plant products and combinations thereof.

14. The acidified shelf-stable cheese composition of claim 11 wherein said proteinaceous material is a non casein-containing proteinaceous material present at a level sufficient to provide from about 1.0 weigh percent to about 5.0 weigh percent non casein protein in the cheese product.

15. The acidified shelf-stable cheese composition of claim 14 wherein said non casein-containing proteinaceous material is selected from the group consisting of whey solids, liquid whey, whey concentrate, whey protein concentrate and whey based cheese and combinations thereof.

16. The acidified shelf-stable cheese composition of claim 11 wherein said water is present at in an amount of about 40.0 weigh percent to about 80.0 weigh percent of said cheese composition.

17. The acidified shelf-stable cheese composition of claim 11 wherein said inorganic emulsifier is present at a level sufficient to provide from about 0.1 weight percent to about 0.5 weight percent of the pasteurized shelf-stable cheese.

18. The acidified shelf-stable cheese composition of claim 11 wherein said inorganic emulsifier is selected from the group consisting of monophosphates, diphosphates, triphosphates, polyphosphates, citrates and combinations thereof.

19. The shelf-stable cheese of claim 11 wherein said inorganic emulsifier has pH reduction characteristics of the cheese composition such as monobasic phosphates.

20. The acidified shelf-stable cheese composition of claim 11 wherein said acidifying agent is present at a level sufficient to provide a pH of about 4.6 or below in the cheese product.

21. The acidified shelf-stable cheese composition of claim 11 wherein said acidifying agent is selected from the group consisting of organic acids such as acetic, adipic, citric, malic, lactic, succinic, ascorbic, benzoic, erythorbic, propionic, sorbic, tartaric, glucono delta-lactone, organic acids such as phosphoric, sulfuric and hydrochloric acids, naturally and artificially acidified products and food products and combinations thereof.

22. An acidified shelf-stable cheese composition of pH about or below 4.6, comprising
low buffering capacity proteinaceous material;
fat source;
acidifying agent; and
texture enhancing agent

23. The acidified shelf-stable cheese composition of claim 22 wherein said low buffering capacity proteinaceous material is present at a level sufficient to provide from about 1.0 to about 5.0 weigh percent protein in the cheese product.

24. The acidified shelf-stable cheese composition of claim 22 wherein said low buffering capacity proteinaceous material is selected from the group consisting of whey solids, liquid whey, whey concentrate, whey protein concentrate and whey based cheese and combinations thereof.

25. The acidified shelf-stable cheese composition of claim 22 wherein said fat source is selected from the group consisting of coconut oil, palm and palm kernel oil, corn oil, cottonseed oil, soybean oil, safflower oil, partially hydrogenated vegetable shortening, animal fat, butterfat and combinations thereof.

26. The acidified shelf-stable cheese composition of claim 22 wherein said acidifying agent is selected from the group consisting of organic acids such as acetic, adipic, citric, malic, lactic, succinic, ascorbic, benzoic, erythorbic, propionic, sorbic, tartaric, glucono delta-lactone, organic acids such as phosphoric, sulfuric and hydrochloric acids, naturally and artificially acidified products and food products and combinations thereof.

26. The acidified shelf-stable cheese composition of claim 22 wherein said texture enhancing agent is present at a level sufficient to provide from about 0.1 weight percent to about 10.0 weight percent of the pasteurized shelf-stable cheese.

27. The acidified shelf-stable cheese composition of claim 22 wherein said texture enhancing agent is selected from a group consisting of starches, carbohydrates, hydrocolloids and textural proteins and combinations thereof.

28. An acidified shelf-stable cheese composition of pH about or below 4.6, comprising
texture enhancing agent;
fat source;
water;
Cheese color and flavor; and
acidifying agent

29. The acidified shelf-stable cheese composition of claim 28 wherein said texture enhancing agent is present at a level sufficient to provide from about 0.1 weight percent to about 10.0 weight percent of the pasteurized shelf-stable cheese.

30. The acidified shelf-stable cheese composition of claim 28 wherein said texture enhancing agent is selected from a group consisting of starches, carbohydrates, hydrocolloids and textural proteins and combinations thereof.

31. The acidified shelf-stable cheese composition of claim 28 wherein said fat source is selected from the group consisting of coconut oil, palm and palm kernel oil, corn oil, cottonseed oil, soybean oil, safflower oil, partially hydrogenated vegetable shortening, animal fat, butterfat and combinations thereof.

32. The acidified shelf-stable cheese composition of claim 28 wherein said water is present at in an amount of about 40.0 weigh percent to about 80.0 weigh percent of said cheese composition.

33. The acidified shelf-stable cheese composition of claim 28 wherein said acidifying agent is selected from the group consisting of organic acids such as acetic, adipic, citric, malic, lactic, succinic, ascorbic, benzoic, erythorbic, propionic, sorbic, tartaric, glucono delta-lactone, organic acids such as phosphoric, sulfuric and hydrochloric acids, naturally and artificially acidified products and food products and combinations thereof.

34. A kit comprising
about 0.1 weight percent to 3.0 weight percent a suitable proteinaceous material;
about 50.0 weight percent to about 80.0 weight percent moisture;
about 0.2 weight percent to about 1.0 weight percent an acidifying agent.

35. The kit of claim 34 wherein said proteinaceous material is a casein-containing proteinaceous material present at a level sufficient to provide from about 0.05 weight percent to about 3.0 weight percent casein in the cheese product.

36. The kit of claim 34 wherein said proteinaceous material is a non casein-containing proteinaceous material present at a level sufficient to provide from about 0.05 weigh percent to about 3.0 weigh percent non casein protein in the cheese product.

37. A method of preparing an acidified shelf stable cheese composition, said method comprising
(a) providing a starting proteinaceous material;
(b) mixing with said material water;
(c) pasteurizing said mixture; and
(d) incorporating with said mixture an acidifying agent in an amount sufficient to provide a predetermined pH level such that said cheese is shelf-stable.

38. The method as defined in claim 37 wherein step (a) includes the step of mixing casein-containing and non-casein containing materials.

39. The method as defined in claim 37 wherein step (d) includes the step of mixing the said mixture with an acidifying agent in order to control the pH of the said mixture to be about 4.6 or lower.

40. A method of preparing a shelf stable cheese composition, said method comprising
(a) providing a starting proteinaceous material;
(b) mixing with said material an emulsifier;
(c) mixing the said mixture with texture enhancing agent; and
(d) incorporating with previous mixture an acidifying agent in an amount sufficient to provide a predetermined pH level such that said cheese is shelf-stable

41. The method as defined in claim 40 wherein step (a) includes the step of mixing casein-containing and non-casein containing materials.

42. The method as defined in claim 41 wherein step (b) includes the step of mixing the said starting pertinacious material with monobasic phosphate emulsifier.

43. The method as defined in claim 41 wherein step (c) includes the step of blending carbohydrates and hydrocolloids, then adding the said blend to the said mixture.

44. The method as defined in claim 41 wherein step (d) includes the step of mixing the said mixture with an acidifying agent in order to control the pH of the said mixture to be about 4.6 to about 3.0.

45. A method of preparing an acidified shelf stable cheese like product with a pH of 4.6 or lower, said method comprising
(1) providing a starting blend of texture modifiers;
(2) adding sufficient amount of water to obtain a slurry of predetermined moisture content;
(3) adding sufficient amounts of cheese flavor and color to obtain a predetermined cheese like taste and color; and
(4) adding sufficient amount of acidifying agents in an amount sufficient to provide the predetermined acidity level.
